(19) United States
(12) Patent Application Publication
(10) Pub. No.: US 2003/0213658 A1
(43) Pub. Date: Nov. 20, 2003

(54) Disc brake

(75) Inventor: Haruhisa Baba, Kariya-shi (JP)

Correspondence Address: BURNS, DOANE, SWECKER & MATHIS, L.L.P., P.O. Box 1404, Alexandria, VA, 22313-1404, US

(73) Assignee: ADVICS CO., LTD.

(21) Appl. No.: 10/436,160

(22) Filed: May 13, 2003

(30) Foreign Application Priority Data
May 16, 2002 (JP) 2002-141354

(51) Int. Cl. F16D 65/38

(52) U.S. Cl. 188/73.37; 188/250 G; 188/250 E

(57) ABSTRACT

In a disc brake, an anti-squeal shim plate is disposed between the backing plate of each pad and a corresponding press member which presses the pad toward a disc rotor. The press member presses the pad against the disc rotor via the anti-squeal shim plate in order to generate braking force. A plurality of dimples are provided on the anti-squeal shim plate in order to limit to a specific area a press contact area between the backing plate and the press member during braking with very small pressing force.

### BACKGROUND OF THE INVENTION

1. Field of the Invention

The present invention relates to a disc brake, and more particularly to a disc brake in which a shim plate for preventing generation of squeal during braking (hereinafter referred to as an “anti-squeal shim plate”) is interposed between a backing plate of a pad and a press member for pressing the pad toward a disc rotor.

2. Description of the Related Art

A disc brake of the above-mentioned type is disclosed in, for example, Japanese Patent Application Laid-Open (kokai) No. 10-184743. In such a disc brake, a press member presses a pad against a disc rotor via a shim plate in order to generate braking force. The shim plate employed in the disc brake disclosed in the above-mentioned publication is a layered plate consisting of a base layer and heat-resistant rubber layers laminated on opposite surfaces of the base layer. However, in some disc brakes, the layered plate (rubber-coated shim) is employed in combination with a shim plate made of SUS (SUS shim) laminated on the layered plate.

In the above-described conventional disc brake, squeal generated during braking is reduced through absorption of vibration and stabilization of surface pressure distribution, which are achieved by the shim plate disposed between the backing plate of the pad and the press member. However, in the conventional disc brake, a contact surface of the backing plate and a contact surface of the press member which come into contact with each other are each formed by a completely flat surface. Therefore, the surface pressure distribution can be stabilized during braking with high pressing force. However, during braking with very small pressing force (e.g., during braking with a very low oil pressure of about 0.5 Mpa or less), the surface pressure distribution (the state of contact between the backing plate and the press member via the shim plate) varies among different braking operations, because the press contact area (the contact area in which the contact surface of the backing plate and the contact surface of the press member which come into contact with each other) is very small during such braking with very small pressing force. Therefore, during braking with very small pressing force (braking with very low oil pressure), the surface pressure distribution is difficult to stabilize, because of the above-mentioned small press contact area and insufficient accuracy of the shim palate, with the possible result of failure to sufficiently attain the squeal prevention effect by the shim plate.

### SUMMARY OF THE INVENTION

In view of the foregoing, an object of the present invention is to provide a disc brake which can prevent generation of squeal during braking with very small pressing force (during braking with very low oil pressure).

In order to achieve the above object, the present invention provides a disc brake comprising a disc rotor; a pad having a backing plate; a press member for pressing the pad toward the disc rotor; an anti-squeal shim plate disposed between the press member and the backing plate of the pad; and press-contact-surface limiting means for limiting to a specific area a press contact area between the backing plate and the press member during braking with very small pressing force (during braking with very low oil pressure).

By virtue of the above-described configuration, during braking with very small pressing force, the press member comes into contact with the backing plate in the specific areas via the anti-squeal shim plate, whereby the state of contact between the backing plate and the press member via the anti-squeal shim plate becomes stable or consistent. Therefore, during braking with very small pressing force, the pad behaves in a stable or consistent manner, whereby generation of squeal during braking with very small pressing force can be effectively prevented.

Preferably, the press-contact-surface limiting means is constituted by a plurality of dimples provided on the anti-squeal shim plate or the backing plate at specific locations.

In this case, since the press-contact-area limiting means is constituted by a plurality of dimples provided on the anti-squeal shim plate or the backing plate at specific locations, the press-contact-area limiting means can be easily provided at low cost.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a vertical cross-sectional view of a disc brake according to one embodiment of the present invention;

FIG. 2 is a rear view of a pad shown in FIG. 1 to which an anti-squeal shim plate is attached;

FIG. 3 is a partial enlarged cross-sectional view of the anti-squeal shim plate and the pad shown in FIG. 2;

FIG. 4 is a graph showing, in a compared manner, the squeal generation rate in the case of the disc brake according to the present invention (invented brake) and that in the case of a conventional disc brake (conventional brake);

FIGS. 5A and 5B are rear views each showing an embodiment in which dimples are provided on the anti-squeal shim plate in an adjusted arrangement;

FIGS. 6A and 6B are rear views each showing an embodiment in which the dimples on the anti-squeal shim plate have a modified shape;

FIG. 7 is a partial enlarged cross-sectional view corresponding to FIG. 3 and showing an embodiment in which the dimples on the anti-squeal shim plate are open to the opposite direction;

FIG. 8 is a partial enlarged cross-sectional view corresponding to FIG. 3 and showing an embodiment in which dimples are provided on the backing plate of the pad; and

FIG. 9 is an enlarged cross-sectional view of a main portion of an embodiment in which dimples are provided on the base plate of a rubber-coated shim of the anti-squeal shim plate.

### DESCRIPTION OF THE PREFERRED EMBODIMENTS

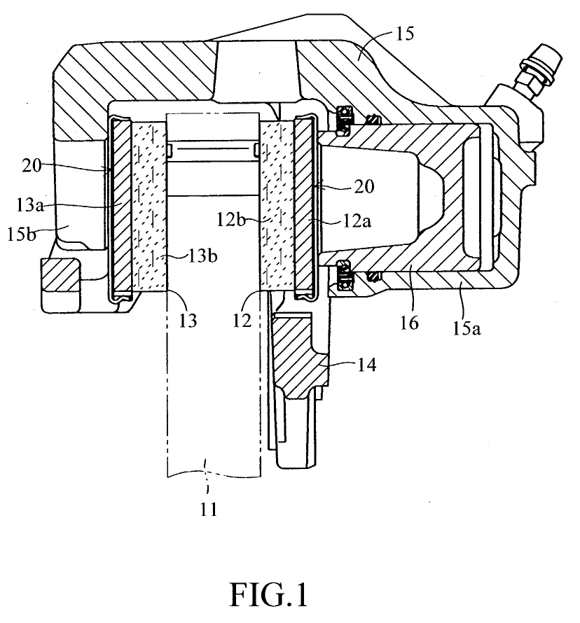

Embodiments of the present invention will now be described with reference to the drawings. FIGS. 1 to 3 show a disc brake according to an embodiment of the present invention. In this disc brake, an inner pad 12 and an outer pad 13, which nip and brake a disc rotor 11, are mounted to a mounting 14 to be movable in the direction of the rotor axis (the left-right direction in FIG. 1). Further, a movable caliper 15 is mounted to the mounting 14 to be movable in the direction of the rotor axis.

The inner pad 12 includes a backing plate 12a and a lining 12b. The inner pad 12 is pressed and moved toward the disc rotor 11 by means of a piston 16, which is accommodated in a cylinder portion 15a of the movable caliper 15 to be movable in the direction of the rotor axis. Further, an anti-squeal shim plate 20 is attached to the backing plate 12a of the inner pad 12, so that the anti-squeal shim plate 20 is interposed between the backing plate 12a and the piston 16.

Meanwhile, the outer pad 13 includes a backing plate 13a and a lining 13b. The outer pad 13 is pressed and moved toward the disc rotor 11 by means of a reaction arm portion 15b of the movable caliper 15 which overhangs the pads 12 and 13. Further, an anti-squeal shim plate 20 is attached to the backing plate 13a of the outer pad 13, so that the anti-squeal shim plate 20 is interposed between the backing plate 13a and the reaction arm portion 15b.

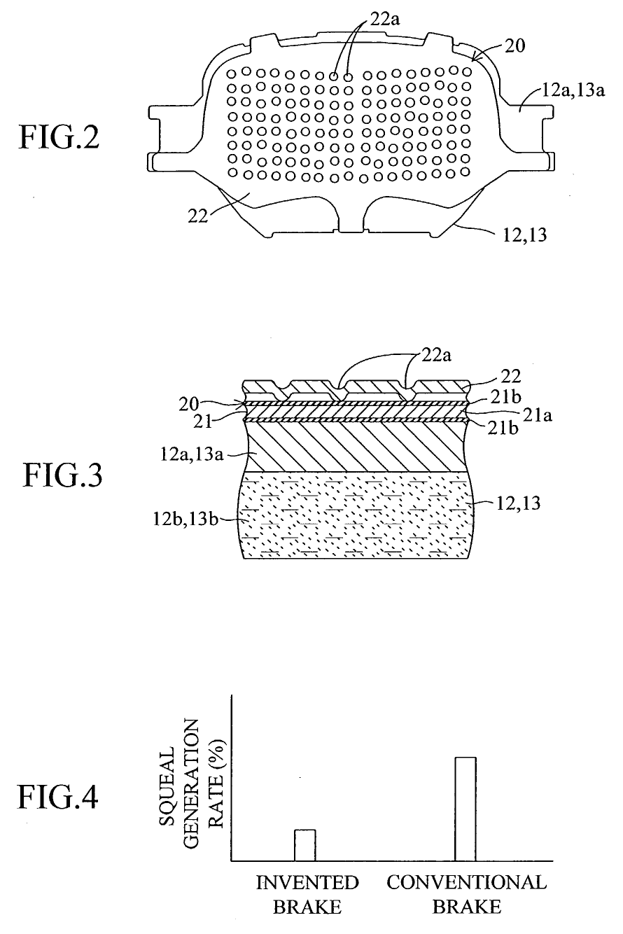

As shown in FIGS. 2 and 3, each of the anti-squeal shim plates 20 is composed of a rubber-coated shim 21 attached to the back surface of the backing plate 12a or 13a of the corresponding pad 12 or 13, and an SUS shim 22 attached to the back surface of the rubber-coated shim 21. The rubber-coated shim 21 is a layered plate consisting of a base plate 21a and a heat-resistant rubber layer 21b laminated on each of opposite surfaces of the base plate 21a (or only one surface of the base plate 21a). The SUS shim 22 is a plate made of stainless steels.

The disc brake having the above-described configuration operates as follows. During braking, pressurized oil is supplied to the cylinder portion 15a of the movable caliper 15, whereby the pressurized oil causes the piston 16 to press the inner pad 12 toward the disc rotor 11 via the anti-squeal shim plate 20, with generation of a reaction force which causes the reaction arm portion 15b of the movable caliper 15 to press the outer pad 13 toward the disc rotor 11 via the anti-squeal shim plate 20. Therefore, the inner pad 12 and the outer pad 13 are pressed against the disc rotor 11, so that the inner pad 12 and the outer pad 13 press against the disc rotor 11 to thereby generate a braking force.

In the disc brake of the present embodiment, as shown in an exaggerated manner in FIG. 3, a plurality of dimples 22a are formed on the SUS shim 22 of the anti-squeal shim plate 20 by means of press forming. The dimples 22a serve as press-contact-surface limiting means for limiting to a specific area the press contact area between the backing plate 12a or 13a and the piston 16 or the reaction arm portion 15b (press member) during braking with very small pressing force (during braking with very low oil pressure of about 0.2 to 0.5 Mpa). The dimples 22a are each formed of a small bottomed round hole having a depth of about 0.1 to 0.4 mm (the depth may be changed freely within the range of 25% to 75% the plate thickness), and are formed on the SUS shim 22 at specific locations in such a manner that the dimples 22a are open to the back surface side, and the bottom portions of the dimples 22a project slightly toward the rubber-coated shim 21.

By virtue of the above-described configuration, during braking with very small pressing force, the piston 16 or the reaction arm portion 15b comes into contact with the backing plate 12a or 13a in the specific areas via the anti-squeal shim plate 20, whereby the state of contact between the backing plate 12a or 13a and the piston 16 or the reaction arm portion 15a via the anti-squeal shim plate 20 becomes stable or consistent. Therefore, during braking with very small pressing force, the pads 12 and 13 behave in a stable or consistent manner, whereby, as shown in FIG. 4, generation of squeal during braking with very small pressing force can be effectively prevented. Notably, the bar labeled “INVENTED BRAKE” in FIG. 4 represents a generation rate of squeal during braking with very small pressing force in the disc brake of the present embodiment, whereas the bar labeled “CONVENTIONAL BRAKE” in FIG. 4 represents a generation rate of squeal during braking with very small pressing force in a conventional disc brake in which the above-described dimples 22a are not provided on the SUS shim 22 of the anti-squeal shim plate 20.

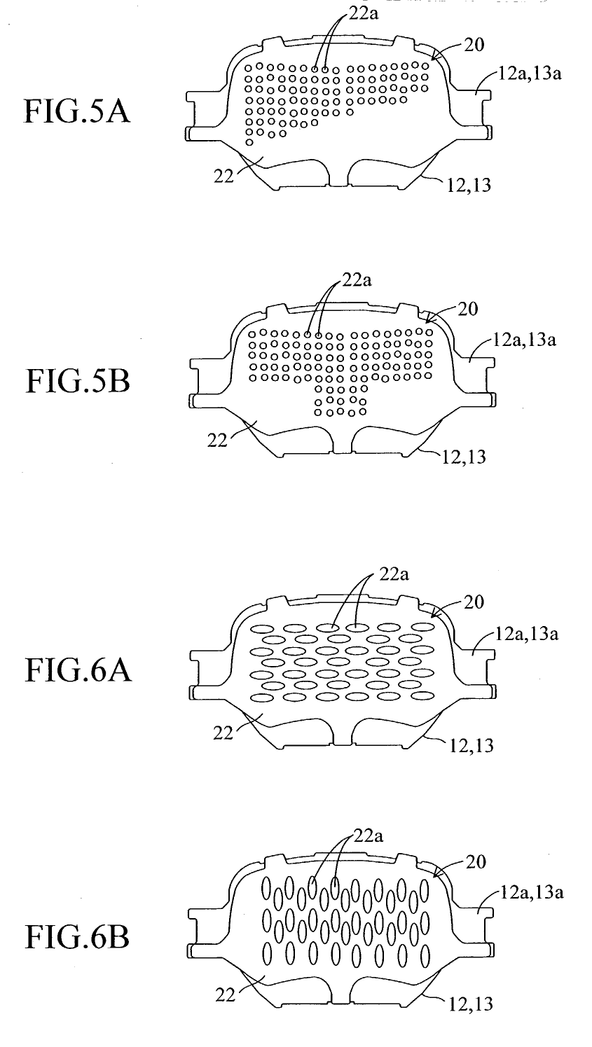

In the disc brake of the present embodiment, a plurality of dimples 22a are provided on the SUS shim 22 of the anti-squeal shim plate 20 at specific locations in order to constitute the press-contact-area limiting means. Since the dimples 22a can be easily formed by means of press forming, the press-contact-area limiting means can be provided at low cost. In addition, as shown in FIGS. 5A and 5B, without changing the basic shape of the SUS shim 22, the press-contact-area limiting means can be easily adjusted by adjusting the arrangement of the dimples 22a.

In the above-described embodiment, the plurality of dimples 22a each assume the shape of a small round hole. However, as shown in FIGS. 6A and 6B, the dimples 22a may be formed in the shape of a small elliptic hole or a small oval hole. In the embodiment shown in FIG. 6A, each of the dimples 22a is elongated in the left-right direction in the drawing, which configuration is effective in the case in which an action of damping vibrations in the top-bottom direction in the drawing is needed. In the embodiment shown in FIG. 6B, each of the dimples 22a is elongated in the top-bottom direction in the drawing, which configuration is effective in the case in which an action of damping vibrations in the left-right direction in the drawing is needed.

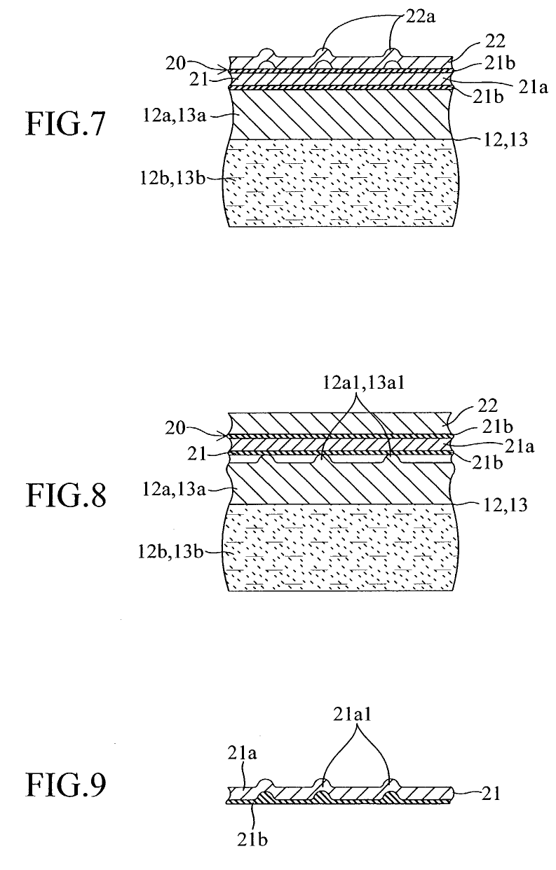

In the above-described embodiment, the plurality of dimples 22a are formed in such a manner that the dimples 22a are open to the back surface side, and the bottom portions of the dimples 22a project slightly toward the rubber-coated shim 21. However, as shown in FIG. 7, the plurality of dimples 22a may be formed in such a manner that the dimples 22a are open to the side toward the rubber-coated shim 21, and the bottom portions of the dimples 22a project slightly toward the back surface side. In the above-described embodiment, the plurality of dimples 22a are provided on the SUS shim 22. However, as shown in FIG. 8, a plurality of dimples 12a1 (13a1) may be provided on the backing plate 12a (13a) of the pad 12 (13). Alternatively, as shown in FIG. 9, a plurality of dimples 21a1 may be provided on the base plate 21a of the rubber-coated shim 21.

Obviously, numerous modifications and variations of the present invention are possible in light of the above teachings. It is therefore to be understood that within the scope of the appended claims, the present invention may be practiced otherwise than as specifically described herein.

What is claimed is:

1. A disc brake comprising:
a disc rotor;
a pad having a backing plate;
a press member for pressing the pad toward the disc rotor;
an anti-squeal shim plate disposed between the press member and the backing plate of the pad; and
press-contact-surface limiting means for limiting to a specific area a press contact area between the backing plate and the press member during braking with very small pressing force.

2. A disc brake according to claim 1, wherein the press-contact-surface limiting means is constituted by a plurality of dimples provided on the anti-squeal shim plate or the backing plate at specific locations.
